(19) United States
(12) Patent Application Publication
(10) Pub. No.: US 2009/0172172 A1
(43) Pub. Date: Jul. 2, 2009

(54) SYSTEMS AND METHODS FOR ENABLING PEER-TO-PEER COMMUNICATION AMONG VISITORS TO A COMMON WEBSITE

(76) Inventors: Erik Lambert Graham, New York, NY (US); Justin Robert Head, Philadelphia, PA (US); Jeffrey William Leigh, Goshen, CT (US); David Andrew Smith, Conroe, TX (US); Gabriel Donovan Huntington, Washington, DC (US); Tom Spilman, Dallas, TX (US)

Correspondence Address: CHOATE, HALL & STEWART LLP, TWO INTERNATIONAL PLACE, BOSTON, MA, 02110, US

(21) Appl. No.: 12/340,137

(22) Filed: Dec. 19, 2008

Related U.S. Application Data
(60) Provisional application No. 61/016,234, filed on Dec. 21, 2007.

(51) Int. Cl. G06F 15/16

(52) U.S. Cl. 709/227

(57) ABSTRACT

In one aspect, a method for methods and systems for enabling peer-to-peer communication among visitors to a common website includes determining, by a server unaffiliated with a first URL, that a first computer is accessing the first URL via a first web browser. The method includes determining, by a server, that a second computer is accessing a second URL via a second web browser, the second URL sharing at least a hostname with the first URL. The method includes sending, from a server to the second computer, address information identifying the first computer. The method includes establishing a connection between the second computer and the first computer. In one embodiment, the method includes displaying, to a user of the first computer, a three-dimensional environment incorporating the first web browser.

### RELATED APPLICATION

The present application claims priority to U.S. Provisional Patent Application Ser. No. 61/016,234, entitled “Systems and Methods for Enabling Peer-to-Peer Communication Among Visitors to a Common Web Site,” filed Dec. 21, 2007, which is incorporated herein by reference.

### FIELD OF THE INVENTION

This disclosure generally relates to systems and methods for enabling website visitors to communicate. In particular, this disclosure relates to systems and methods for enabling peer-to-peer communication among visitors to a common website.

### BACKGROUND OF THE INVENTION

Many applications currently exist enabling users of computers at remote locations to interact with one another. These applications include electronic mail, instant messaging, videoconferencing, and virtual worlds.

Many web browsers currently exist which allow users of a computer to browse websites. A website may comprise one or more groups of related web pages. The websites a user visits may reflect interests of the user. Although some web pages may include chat or messaging applications, these applications may be limited in communicative richness. Further, many web pages do not feature any ability for users viewing the page to communicate with one another.

### SUMMARY OF THE INVENTION

The methods and systems described herein allow visitors to a website to connect and communicate with one another regardless of the operator or design of the website. Broadly speaking, these systems include a web browser which sends uniform resource locators of currently viewed pages to a central server which collects the currently viewed uniform resource locators of a number of users. Upon receiving a user's currently viewed uniform resource locator, the server responds with an identification of other users also viewing the same or similar pages. The user's computer can then directly connect to the other computers viewing the page, allowing the users to communicate with each other. In this way, a number of people visiting the same site can communicate with each other to share thoughts, opinions, and interests. Further, this communication can happen without any involvement by an administrator of the website, or any changes to the website.

In one aspect, a method for enabling peer-to-peer communication among visitors to a common website includes: determining, by a server unaffiliated with a first uniform resource locator, that a first computer is accessing the first uniform resource locator via a first web browser; determining, by the server, that a second computer is accessing a second uniform resource locator via a second web browser, the second uniform resource locator sharing at least a hostname with the first uniform resource locator; sending, from the server to the second computer, address information identifying the first computer; and establishing a connection between the second computer and the first computer.

In another aspect, a system for enabling peer-to-peer communication among visitors to a common website includes a first computer comprising a first web browser, a server, and a second computer. The server determines that the first computer is accessing a first uniform resource locator via the first web browser, wherein the server is unaffiliated with the first uniform resource locator. The server determines that a second computer is accessing a second uniform resource locator via a second web browser, the second uniform resource locator sharing at least a hostname with the first uniform resource locator. The server sends, to the second computer, address information identifying the first computer. The second computer establishes a connection to the first computer.

In still another aspect, a system for enabling peer-to-peer communication among visitors to a common website includes: a display comprising a first web browser; a processor, in communication with the display, which identifies a uniform resource locator currently accessed by the user via the first web browser; and a transceiver, in communication with the processor, which receives address information identifying at least one second computing device as accessing a second uniform resource locator via a second web browser, the second uniform resource locator sharing at least a hostname with the first uniform resource locator, and establishing a connection with the at least one second computing device.

In yet another aspect, a method enabling peer-to-peer communication among visitors to a common website includes: displaying, by a computer, a first web browser to a user; identifying, by the computer, a uniform resource locator currently accessed by the user via the first web browser; receiving, by the computer, address information identifying at least one second computing device as accessing a second uniform resource locator via a second web browser, the second uniform resource locator sharing at least a hostname with the first uniform resource locator; and establishing a connection between the computer and the second computer.

### BRIEF DESCRIPTION OF THE DRAWINGS

These and other aspects of this disclosure will be readily apparent from the detailed description below and the appended drawings, which are meant to illustrate and not to limit the disclosure, and in which:

FIG. 1 is a block diagram of one embodiment of a system for enabling clients viewing a website to communicate with each other;

FIGS. 2A and 2B depict block diagrams of a typical computer 200 useful as client computing devices and server computing devices;

FIG. 3 is a flow diagram of one embodiment of a method for computers accessing a website to communicate with one another;

FIG. 4 is a flow diagram of one embodiment of a second method for computers accessing a website to communicate with one another;

FIG. 5 is a block diagram of an example packet header structure;

FIG. 6 is a block diagram of a number of example packet flows; and

FIG. 7. a screen shot depicts one embodiment of a system in which a first computer displays a three-dimensional environment displaying an avatar associated with a user of a second computer.

### DETAILED DESCRIPTION OF THE INVENTION

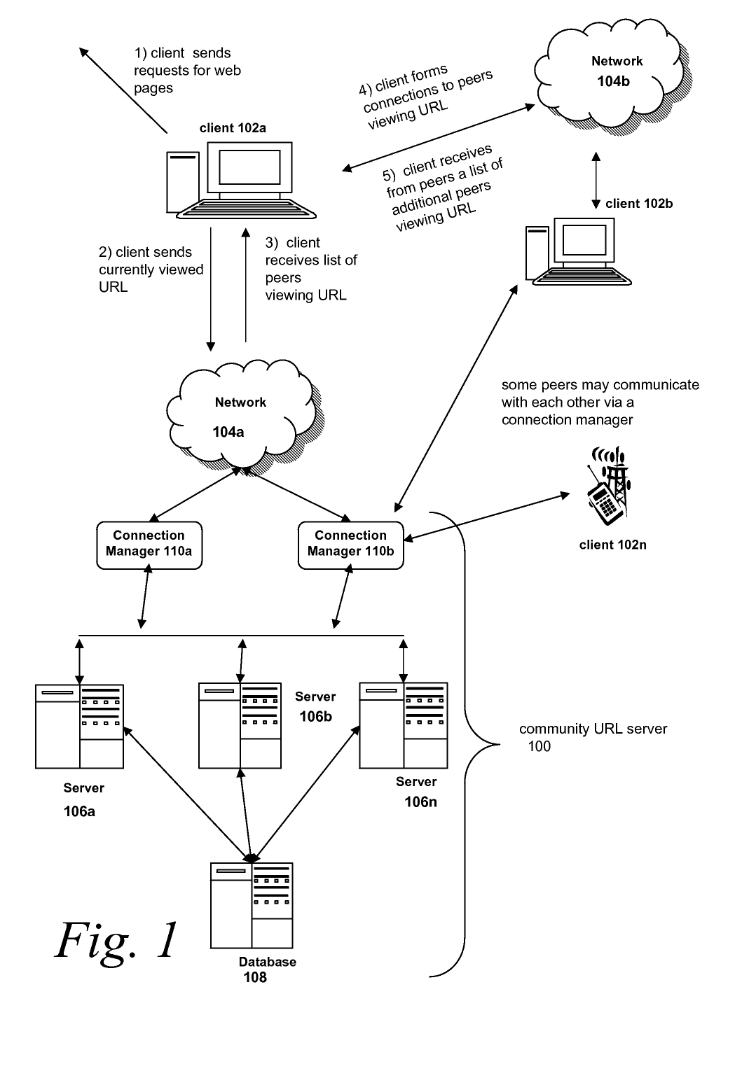

Referring now to FIG. 1, a block diagram of one embodiment of a system for enabling clients viewing a website to communicate with each other is shown. In brief overview, a client 102a, contains a web browser which a user uses to view websites. As the user visits a website, the client 102a sends a uniform resource locator (URL) of a currently viewed website to a community URL server 100. The community URL server responds with a list of other clients also viewing the website. The client 102a may then establish direct connections to the identified clients for communication. In some instances, clients (such as clients 102b and 102c) may connect through a connection manager 110a, 110b (generally 110). This may be done in instances where a direct connection cannot be established between two clients. Once two clients are connected, they may communicate in any manner, including without limitation sending text, voice, files images, animations, and videos.

Still referring to FIG. 1, now in greater detail, a web browser executes on a client 102a. A web browser may comprise any software and/or hardware allowing a user to access and view web pages. A web browser may comprise functionality for accessing, viewing, and executing pages comprising any language, including without limitation HTML, DHTML, SVG, Javascript, Java applets, and Flash. In some embodiments, the web browser may comprise a stand-alone application. In some of these embodiments, a web browser may be any publicly available web browser, such as the FIREFOX browser distributed by the Mozilla Foundation. In other embodiments, a web browser may be provided within another application. For example, an application may provide a 3D environment in which a user can freely roam, and the application may include one or more web browsers which allow a user to view web pages within the 3D space.

A web browser executing on a client 102 may send requests to view web pages to any server, and the requests may comprise any URL. In addition to sending the request for a web page to a server hosting the page, the web browser (or any program or programs working in conjunction with the web browser) may send one or more URLs of currently requested and/or viewed pages to a URL community server 100. The client may then receive a response comprising a complete or partial list of other clients who are also currently viewing or requesting those URLs. The client 102a may then provide a user with any functionality to interact with those other users including without limitation sending text, voice, files images, animations, and videos. In some embodiments, the client 102a may display a virtual 3D environment in which web pages appear along with avatars representing one or more other users also viewing the page.

As a user views a website displayed by the client 102a, the client 102a may send a URL corresponding to the website to a community URL server 100 via a network 104a. The client may also connect to any number of other clients 102b . . . 102n via network 104b. The networks 104a, 104b may comprise the Internet, local networks, web servers, file servers, routers, load balancers, databases, computers, servers, network appliances, or any other computing devices capable of sending and receiving information. The networks 104a, 104b may comprise computing devices connected via cables, IR ports, wireless signals, or any other means of connecting multiple computing devices. A network and any devices connected to the networks may communicate via any communication protocol used to communicate among or within computing devices, including without limitation SSL, HTML, XML, RDP, ICA, FTP, HTTP, TCP, IP, UDP, IPX, SPX, NetBIOS, NetBEUI, SMB, SMTP, POP, IMAP, Ethernet, ARCNET, Fiber Distributed Data Interface (FDDI), RS232, IEEE 802.11, IEEE 802.11a, IEEE 802.11b, IEEE 802.11g, IEEE 802.11n, and direct asynchronous connections, or any combination thereof. The networks 104a, 104b may comprise mobile telephone networks utilizing any protocol or protocols used to communicate among mobile devices, including AMPS, TDMA, CDMA, GSM, GPRS or UMTS. The network may comprise a plurality of physically distinct networks, and the network may comprise a plurality of sub-networks connected in any manner. In some embodiments, networks 104a and 104b may comprise the same network. In other embodiments, network 104a and network 104b may have any number of distinct nodes.

A client 102a may also connect to any number of other clients 102b, 102n who are viewing the same website as the client 102a via a network 104b. These connections may comprise any type or form of direct and/or indirect connection. For example, in some cases, a client may connect to another client residing on the same local network. In other embodiments, a client may connect to another client via the internet. In other embodiments, a client may connect to another client via a connection manager 110 (such as clients 102b and 102n). In still other embodiments, a client may connect to another client via a peer relay.

In some embodiments, a client may receive a listing of other clients also visiting a website from other clients. In this way, a client may discover other clients visiting a website by “spidering,” wherein each peer the client contacts sends a list of more peers to contact.

A community URL server 100 may comprise any number of servers which facilitates, directly and/or indirectly, communication between users visiting a common website. A community URL server may comprise any combination of hardware and software. Although FIG. 1 shows a configuration with separate connection managers, servers, and databases, in some embodiments any of the functionality described herein may be performed across any number of appliances. In some embodiments, a community URL server may be geographically distributed. In some embodiments, only certain portions of a community URL server may be geographically distributed. For example, a community URL server 100 may comprise a number of connection managers at diverse locations, all of which communicate to a bank of servers 106 in a single location. In some embodiments, any or all of the functionality of a community URL server 100 may be decentralized and performed on a peer-to-peer basis.

In some embodiments, a community URL server 100 comprises a number of connection managers 110a, 110b (generally 110). Connection managers 110 may comprise any computing devices which are used to pass communications either from a client to a server or from one client to another client. For example, in cases where a peer-to-peer connection cannot be established between two clients (such as if they are separated by one or more firewalls or NAT devices), the clients may communicate with each other through a connection manager. In one embodiment, the two clients communicate with each other through a connection manager executing on a third client. In another embodiment, a third client providing at least some of the functionality of the connection manager and connecting two clients to each other may be referred to as a relay manager. In some embodiments, individual connection managers may each comprise a separate appliance. In some embodiments, a plurality of connection managers may run on a single appliance.

A community URL server 100 may also comprise any number of servers 106a . . . 106n which respond to client requests. The servers 106 may receive communications from a number of clients indicating URLs which are currently being viewed. In some embodiments, the servers 106 may also receive communications indicating when a user has stopped viewing a given web page. The servers 106 may maintain at least one list, table, or other data structure of users visiting a given site. In some embodiments, some or all of this data structure may be maintained using at least one database 108.

Upon receiving an indication that a given client 102 is visiting a URL, the server may respond to the client with a complete or partial list of other clients visiting the URL. In embodiments, where the server 106 responds with a partial list, the server may use any method for determining the subset of clients that are sent. In some embodiments, a server 106 may select a random subset of clients. In other embodiments, a server 106 may select a subset of clients identified based on a level of distance between each of the subset of clients and the requesting client. In one of these embodiments, the server 106 selects a client having a minimal geographic distance from the requesting client; for example, a user may specify a geographic range within which other users may be considered to be substantially close enough to the user to be within the minimal geographic distance (e.g., same neighborhood, town, city, county, state, country, political region, or other geographic region). In another of these embodiments, the server 106 selects a client having a minimal networking distance from the requesting client; for example, a user may specify a network range within which other users may be considered to be substantially close enough to the user to be within the minimal networking distance (e.g., same network address, same network provider, same subset of Internet routers, or other network-based region) In still another of these embodiments, the server selects a client having an avatar graphical depicted in a portion of a three-dimensional graphical environment that also depicts an avatar of the requesting user; for example, a three-dimensional graphical environment may be provided by a plurality of servers, a subset of which are each responsible for at least a portion of the environment (the subset may be referred to as a zone), and the server 106 may select a client whose avatar is rendered within a zone within which an avatar associated with the requesting client is also rendered. This may be referred to as selecting clients based on scoping within the graphical environment. In still other embodiments, a server 106 may select a subset of clients with a past history of interacting with the requesting client. In further embodiments, a server 106 may select a subset of clients identified as friends by the requesting client.

In some embodiments, a server 106 may select a subset of clients accessing the URL within a given time period. In other embodiments, a server 106 may select a subset of clients each of which has identified as a friend at least one client which has identified the given client 102 as a friend. In still other embodiments, a server 106 may select a subset of clients having a similar relationship status as the client 102.

In some embodiments, a server 106 may select a subset of clients that have accessed a subset of URLs accessed by the given client 102. In one of these embodiments, a server 106 may select a subset of clients having stored an identification of a URL in a file of preferred websites, the identified URL also stored by the given client 102 in a file of preferred websites; for example, the subset of clients and the given client 102 may have similarities in their bookmarked websites.

In other embodiments, a server 106 may select a subset of clients that have identified at least one common topic of interest as the given client 102. In one of these embodiments, a topic of interest may include, without limitation, family, technology, sports, design, humor, animals, art, graphics, music, cinema, literature, television, activities, hobbies, linguistics, photography, history, games, science, and academics.

In further embodiments, a server 106 may select a subset of clients that based on tags that the clients have associated with data. In one of these embodiments, a tag is metadata that a user can associate with data, such as web pages, pictures, data files, virtual world objects, or other information. In another of these embodiments, a user associates a tag with data to categorize the data; for example, a user may categorize a web page as relating to an academic topic or categorize an image as relating to a person. In still another of these embodiments, a user selects the tag from a predefined set. In still even another of these embodiments, a user generates tags and categories and there is no requirement that the tag or category accurately describe the data. In still another of these embodiments, a tag may reflect a user opinion of the data; for example, a user may associate a tag with data to indicate a positive interest in the data, or the user may associate a tag with data to indicate disinterest in the data. In yet another of these embodiments, the server 106 may select a subset of clients based on commonalities between tags applied by the clients to data and tags applied by the requesting client to data.

In some embodiments, a server 106 may select a subset of clients each of which has identified a personal characteristic also identified by the requesting client. In one of these embodiments, the personal characteristic may include, without limitation, age, gender, marital status, physical attributes, sexual preferences, geographic location, school affiliation, professional affiliation, and political affiliation. In other embodiments, a server 106 may select a subset of clients each of which has identified a technical characteristic of their computing systems also identified by the requesting client. In one of these embodiments, for example, the technical characteristic may include, without limitation, a system configuration, a network configuration, a processing speed, an operating system, a level of bandwidth, and an input device (such as microphone). In still other embodiments, a server 106 may select a subset of clients each of which has identified a community status also identified by the requesting client. In one of these embodiments, for example, a community status identification may include, without limitation, identification of the client as a beta tester, identification of a date of adoption of the technology by a user of the client, reputation of the user (for example, as identified by other users), status of user as child-safe, and authenticated identity. In further embodiments, a server 106 may use any combination of the above techniques.

In some embodiments, the community URL server 100 may be unaffiliated with any of the servers hosting the URLs for which it receives requests. For example, a client may request, via a web browser, to view a website www.xyz.com. The web browser, in addition to requesting the page www.xyz.com, may also transmit the URL www.xyz.com to a community URL server 100. In this case, the community URL server may be unaffiliated with www.xyz.com or any company operating www.xyz.com. In some embodiments, a single community URL server may allow users viewing any number of websites to interact with other users of those same websites, without requiring any involvement of the operators of those websites.

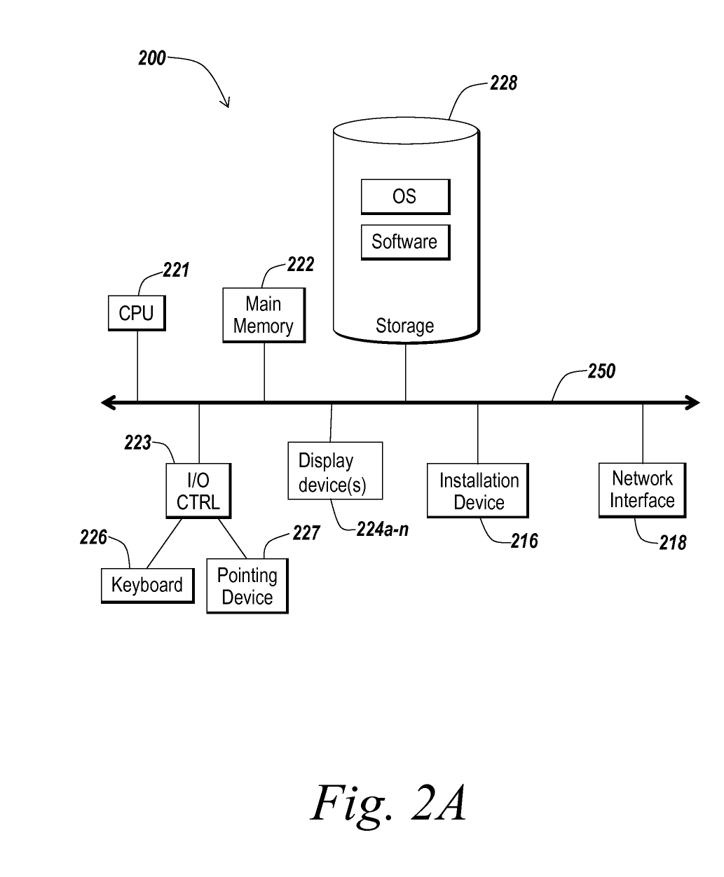

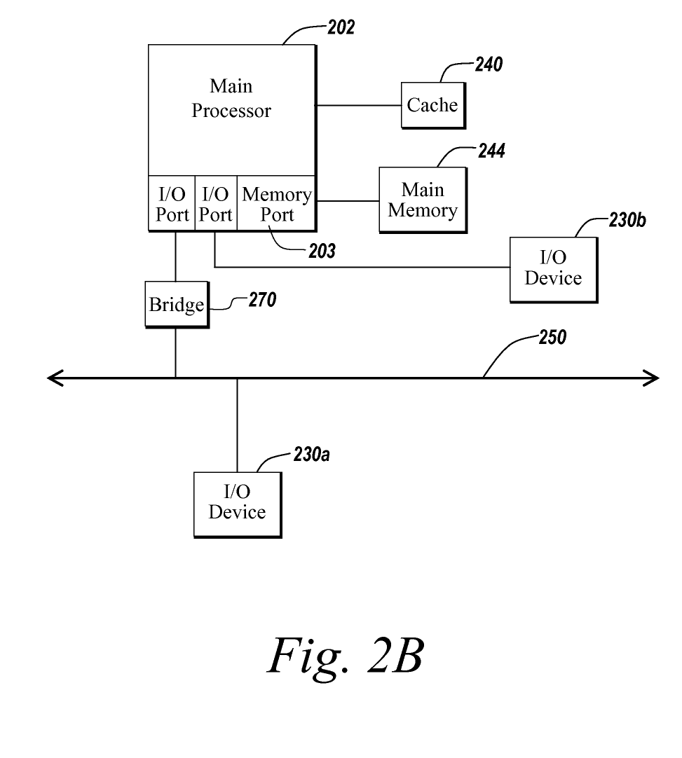

FIGS. 2A and 2B depict block diagrams of a typical computer 200 useful as client computing devices and server computing devices. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 204 via a system bus 250 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 250. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 250. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

The computer system 200 may support any suitable installation device 216, such as a floppy disk drive for receiving floppy disks such as 3.5-inch, 5.25-inch disks or ZIP disks, a CDROM drive, a CD-R/RW drive, a DVD-ROM drive, tape drives of various formats, USB device, hard-drive or any other device suitable for installing software and programs such as any client software, or portion thereof. The computer system 200 may further comprise a storage device 228, such as one or more hard disk drives or redundant arrays of independent disks, for storing an operating system and other related software, and for storing application software programs such as any program related to a client software package 220. Optionally, any of the installation devices 216 could also be used as the storage device 228. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computer system 200 may include a network interface 218 to interface to a Local Area Network (LAN), Wide Area Network (WAN) or the Internet through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET, ADSL, SDSL), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computer system 200 communicates with other computer systems 200′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 218 may comprise a built-in network adapter, network interface card, PCMCIA network card, card bus network adapter, wireless network adapter, USB network adapter, modem or any other device suitable for interfacing the computer system 200 to any type of network capable of communication and performing the operations described herein.

A wide variety of I/O devices 230 may be present in the computer system 200. Input devices include keyboards, mice, trackpads, trackballs, cameras, video cameras, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In some embodiments, the computer system 200 may comprise or be connected to multiple display devices 224a-224n, which each may be of the same or different type and/or form. As such, any of the I/O devices 130a-130n and/or the I/O controller 223 may comprise any type and/or form of suitable hardware, software, or combination of hardware and software to support, enable or provide for the connection and use of multiple display devices 224a-224n by the computer system 200. For example, the computer system 200 may include any type and/or form of video adapter, video card, driver, and/or library to interface, communicate, connect or otherwise use the display devices 224a-224n. In one embodiment, a video adapter may comprise multiple connectors to interface to multiple display devices 224a-224n. In other embodiments, the computer system 200 may include multiple video adapters, with each video adapter connected to one or more of the display devices 224a-224n. In some embodiments, any portion of the operating system of the computer system 200 may be configured for using multiple displays 224a-224n. In other embodiments, one or more of the display devices 224a-224n may be provided by one or more other computer systems, such as computer systems 200a and 200b connected to the computer system 200, for example, via a network. These embodiments may include any type of software designed and constructed to use another computer's display device as a second display device 224a for the computer system 200. One ordinarily skilled in the art will recognize and appreciate the various ways and embodiments that a computer system 200 may be configured to have multiple display devices 224a-224n.

In further embodiments, an I/O device 230 may be a bridge between the system bus 250 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 2A and FIG. 2B typically operate under the control of operating systems, which control scheduling of tasks and access to system resources. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA all of which are manufactured by Microsoft Corporation of Redmond, Wash.; MAC OS, manufactured by Apple Inc., of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 200 can be any workstation, desktop computer, laptop or notebook computer, server, handheld computer, mobile telephone or other portable telecommunication device, media playing device, a gaming system, mobile computer system, or any other type and/or form of computing, telecommunications or media device that is capable of communication and that has sufficient processor power and memory capacity to perform the operations described herein. For example, the computer system 200 may comprise a device of the IPOD family of devices manufactured by Apple Inc., of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In other embodiments, the computer system 200 may have different processors, operating systems, and input devices consistent with the device. For example, in one embodiment the computer 200 is a Treo 180, 270, 1060, 600, 650, 680, 700p, 700w/wx, 750, 755p, 800w, Centro, Pro smart phone manufactured by Palm, Inc. In this embodiment, the TREO smart phone is operated under the control of the PALM OS operating system and includes a stylus input device as well as a five-way navigator device.

In other embodiments, the computer system 200 is a mobile device, such as a JAVA-enabled cellular telephone or personal digital assistant (PDA), such as the i55sr, i58sr, i85s, i88s, i90c, i95cl, i335, i365, i570, I576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computer system 200 is a mobile device manufactured by Nokia of Finland, or by Sony Ericsson Mobile Communications AB of Lund, Sweden.

In still other embodiments, the computer system 200 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, Blackberry Pearl Flip. In yet other embodiments, the computer system 200 is a smart phone, Pocket PC, Pocket PC Phone, or other handheld mobile device supporting Microsoft Windows Mobile Software. Moreover, the computer system 200 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computer system 200 is a digital audio player. In one of these embodiments, the computer system 200 is a digital audio player such as the Apple IPOD, IPOD Touch, IPOD NANO, and IPOD SHUFFLE lines of devices, manufactured by Apple Inc., of Cupertino, Calif. In another of these embodiments, the digital audio player may function as both a portable media player and as a mass storage device. In other embodiments, the computer system 200 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computer system 200 is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computer system 200 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computer system 200 includes a combination of devices, such as a mobile phone combined with a digital audio player or portable media player. In one of these embodiments, the computer system 200 is a smartphone, for example, an iPhone manufactured by Apple Inc., or a Blackberry device, manufactured by Research In Motion Limited. In yet another embodiment, the computer system 200 is a laptop or desktop computer equipped with a web browser and a microphone and speaker system, such as a telephony headset. In these embodiments, the computer systems 200 are web-enabled and can receive and initiate phone calls. In other embodiments, the communications device 200 is a Motorola RAZR or Motorola ROKR line of combination digital audio players and mobile phones.

The computer systems 200 may also be referred to as client nodes, client machines, endpoint nodes, or endpoints. In some embodiments, a computer system 200 has the capacity to function as both a client node seeking access to resources provided by a server and as a server providing access to hosted resources for other computer systems 200.

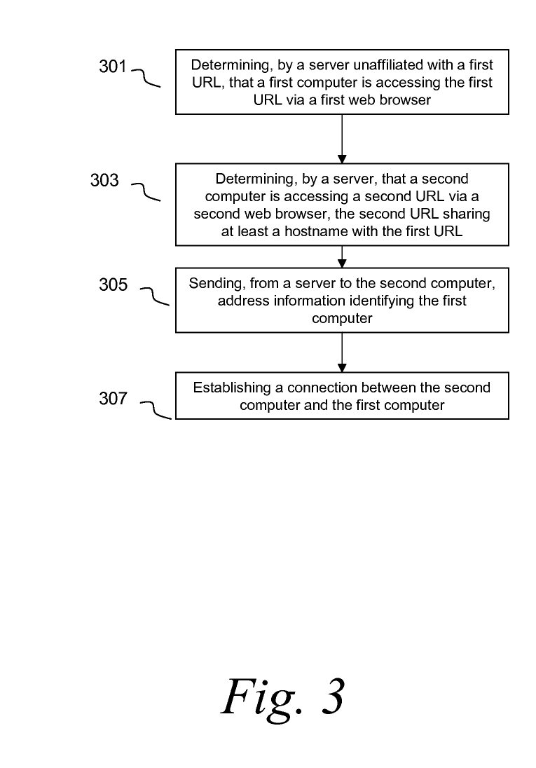

Referring now to FIG. 3, a flow diagram of one embodiment of a method for computers accessing a website to communicate with one another is shown. In brief overview, the method comprises determining, by a server unaffiliated with a first URL, a first computer is accessing the first URL via a first web browser (step 301). The server determines a second computer is accessing a second URL via a second web browser, the second URL sharing at least a hostname with the first URL (step 303). The server sends, to the second computer, address information identifying the first computer (305). A connection is then established between the second computer and the first computer (step 307).

Still referring to FIG. 3, now in greater detail, a server unaffiliated with a first URL, may determine a first computer is accessing the first URL via a first web browser in any manner (step 301). In some embodiments, the server may receive an indication from the computer that a URL is currently being displayed in a web browser. In other embodiments, the server may receive an indication that a URL is currently being requested by a web browser. In one embodiment, the server may be a community URL server 100. In another embodiment, the server may be a component of a community URL server 100, such as a server 106. The first computer may comprise any computing device. In some embodiments, the server may monitor and/or receive communications from any number of clients indicating URLs currently viewed by the client.

In some embodiments, the first URL may comprise the URL of a web page. In other embodiments, the first URL may comprise the URL of a resource embedded within a web page.

The server may determine a second computer is accessing a second URL via a second web browser, the second URL sharing at least a hostname with the first URL in any manner (step 303). The server 106 may use any method to determine the first and second URL share at least a hostname, including without limitation string comparison algorithms, hash tables, and sorted lists.

In some embodiments, the first and second URL are substantially similar. In other embodiments, a server 106 may determine whether a hostname within the first URL is substantially similar to a hostname within a second URLs. In one of these embodiments the server 106 makes this determination prior to sending an indication to the respective computers that another user is visiting a substantially similar URL. In another of these embodiments, the second uniform resource locator is substantially similar to the first uniform resource locator except for one or more query strings. For example, it may be desirable that all users of www.example.com are able to connect and communicate with each other, regardless of whether they are viewing www.example.com/page1 or www.example.com/page2. In still other embodiments, a server 106 may determine that the entire first URL is substantially similar to the entirety of a second URL, prior to determining whether two clients may establish a connection to each other.

In some embodiments, a server 106 may determine whether a portion of the first URL excluding a query string in the URL and a portion of the second URL excluding a second query string in the second URL are substantially similar. In other embodiments, a server 106 may use any other algorithm to determine whether clients viewing two URLs should be notified of each other, including without limitation any combination of the above algorithms. For example, in one of these embodiments, a server 106 may determine for URLs of large and/or popular websites, such as www.yahoo.com, whether all or at least a large portion of the URLs match, while for less popular and/or smaller websites only determine whether the two URLs have substantially similar hostnames. In this way, a visitor to a specific page within a large popular website may not be connected with users of largely unrelated pages hosted by the same site, while potentially allowing all visitors to a small site to see each other.

After determining that the first and second computers are accessing the same or similar URLs, the server may send, to the second computer, address information identifying the first computer in any manner (305). In some embodiments, the server may send an IP address of the first computer. In other embodiments, the server may send an IP address and a port number. In still other embodiments, the server may send any other address information, including information regarding proprietary and/or public addressing protocols. The server may send any information along with the address information, including without limitation a user name, location, connection speed, network distance, and/or avatar information corresponding to the first computer. In some embodiments, the server may send address information of the second computer to the first computer.

In some embodiments, the server may determine a plurality of clients are viewing URLs matching the second URL. The server may send address information for all or any subset of the plurality of clients to the second computer.

A connection may be established between the second computer and the first computer in any manner (step 307). In some embodiments, the second computer may make a connection request to the first computer. In other embodiments, the first computer may make a connection request to the second computer. The connection may be made using any protocol or protocols, including without limitation TCP, IP, UDP, and SSL. It should be understood that the term “connection” as used herein may refer to any exchange of data, and therefore, in addition to encompassing protocols commonly viewed as connection-based such as TCP, also encompasses exchanges of data through protocols such as UDP which may be commonly referred to as “connectionless.” The first and second computer may exchange any data with each other, including without limitation sending at least one of: voice, avatar, image, or text data.

In some embodiments the first and second computers may exchange address information for other computers also viewing the same web page. In some embodiments, upon establishing a connection to a computer based on viewing a web page, a computer may transmit to the computer a list of all other computers the computer knows to also be viewing the web page. In one of these embodiments, recipient computer may then establish connections to any of those other computers that it is not already connected to. In another of these embodiments, the identification of a computer in this way may be referred to as “spidering.”

In some embodiments, the first and second computer may communicate directly, such as by sending each other packets directly addressed to each other. In other embodiments, the first and second computer may communicate via one or more proxies. In one embodiment, the first and second computer may communicate via a connection manager 110. In another embodiment, the first and second computer may communicate through one or more peers. In some embodiments, the first and second computers may communicate through a proxy in response to one or both of the first and second computer residing behind a firewall and/or NAT device.

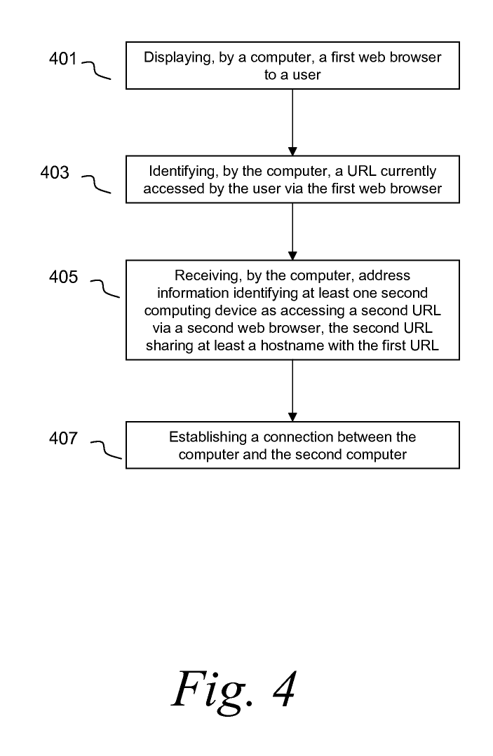

Referring now to FIG. 4, a flow diagram of one embodiment of a second method for computers accessing a website to communicate with one another is shown. In brief overview, the method comprises: displaying, by a computer, a first web browser to a user (step 401); identifying, by the computer, a URL currently accessed by the user via the first web browser (step 403); receiving, by the computer, address information identifying at least one second computing device as accessing a second URL via a second web browser, the second URL sharing at least a hostname with the first URL (step 405); and establishing a connection between the computer and the second computer (step 407). In some embodiments, a client performing the above method may work in conjunction with a server performing steps of the method described in FIG. 3.

Still referring to FIG. 4, now in greater detail, a computer may display a first web browser to a user in any manner (step 401). The first web browser may comprise any application, process, and/or executable which allows a user to view web pages. In some embodiments, the computer may display the web browser as a stand alone application. In other embodiments, the computer may display a web browser within an application. In some embodiments, the web browser display may be altered by one or more applications to incorporate communications with other users viewing the website.

The computer may then identify, by the computer, a URL currently accessed by the user via the first web browser (step 403). In some embodiments, the computer may identify a URL of a web page currently being viewed. In some embodiments, the computer may identify a URL currently in the location bar of the web browser. In other embodiments, the computer may identify a URL of a resource accessed within a web page. For example, the computer may identify a URL of an image, frame, video, or other content within a viewed page.

In some embodiments, after identifying the URL, the computer may transmit an indication that the URL is being accessed to a community URL server 100. In other embodiments, the computer may transmit an indication that the URL is being accessed to a peer.

The computer may then receive address information identifying at least one second computing device as accessing a second URL via a second web browser, the second URL sharing at least a hostname with the first URL (step 405). The computer may receive any type, form, or amount of address information, such as an IP address and/or port. In some embodiments, the computer may receive any other information corresponding to the address information, including without limitation network configuration, network topology, encryption information, hostname, firewall information, NAT information, avatar information, user name, and/or user statistics.

A connection between the computer and the second computer (step 407) may be established in any manner and using any protocol or protocols. In some embodiments, results of the connection may be displayed to a user of the web browser. The connection may then be used to exchange any communication between the computers and the users of the computers.

The following illustrative examples show how the methods and systems discussed above can be used to enable computers accessing a website to communicate with one another. This example is meant to illustrate and not to limit the disclosure.

### Example Network Architecture

In the general architecture of this example, referring back to FIG. 1, the clients 102 may connect up directly to a single connection manager 110. Multiple connection managers 110 can be made available and load balanced to support a larger number of client connections. connection managers are able to connect to a single server 106 or to multiple servers 106 depending on the processing load requirements. Each connection manager 110 may maintain a single and direct socket connection to a server 106, thus creating a processing pipe between the connection manager and server. Servers 106 perform packet processing as well as all database access. Database 108 access may be abstracted through an ODBC interface to allow location of the database to virtually anywhere, but may use direct PostgreSQL API calls for maximum performance. Each connection manager 110 provides packet routing for the external clients to a single or series of servers. The manager 110 may monitor the incoming packets in raw byte level operations, thus allowing for the maximum performance for each socket.

The server 106 acts as the backend processing for client communications, and may include 2 threads for this processing. A socket processing thread administers the manager service connections, accepting incoming raw socket data, and repackaging into packet objects. These class objects are stored off into an “Input” packet list in a FIFO method. A packet processing thread processes the incoming packets created and stored by the socket processing thread. Database access is performed exclusively from this thread. Resulting packet objects are stored back into an “Output” packet list in FIFO method for the socket processing thread to transmit back to the manager thread.

The client communication to a connection manager 110 may be performed through a DLL, and like the server, the client creates 2 threads for communications processing. A socket processing thread administers the connection manager as well as peer-to-peer socket connections. The raw socket data received is converted to a packet object and stored into an “Input” packet list in a FIFO method. In some cases, the only packet that the “Socket” thread actually looks for and examines is a “Logout” Response packet so that the client can close down any open socket connections and flush the buffers. The packet processing is notified of “Packets” through an event semaphore. In some instances, the socket processing passes events directly up to the client event handlers—such instances are mostly related to the manager socket connection information (connecting, disconnecting, etc). This prioritizes these packets over packets in the packet processing thread. A packet processing thread processes the incoming packets created and stored by the socket processing thread. Packets are identified and event notifications are passed up to the client event handlers. The packets are processed until the list is empty, then the thread will sleep until the event semaphore is toggled in order to reduce CPU usage. DLL calls directly insert packets into the socket processing's output packet list in a FIFO method.

### Example Packet Structure

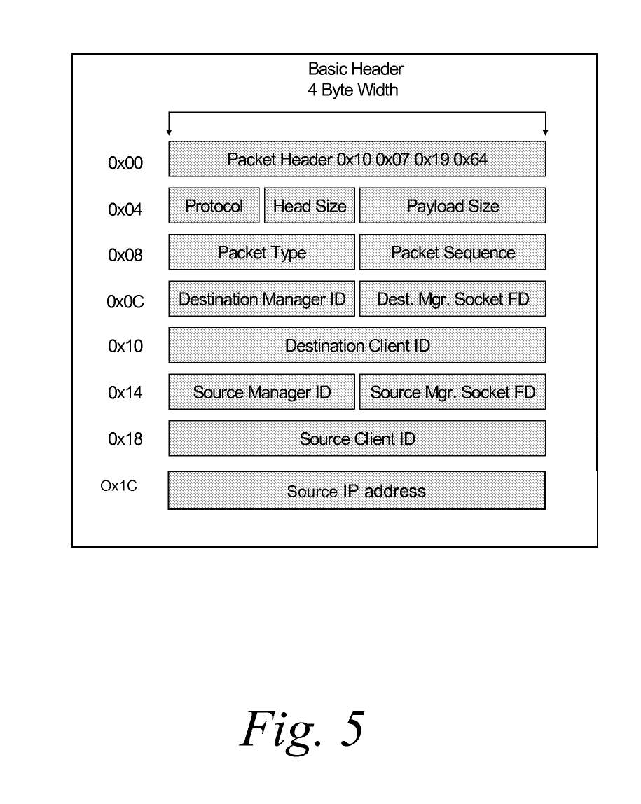

Each packet transmitted between a client 102, a connection manager 110, or a server 106, may contain a “Basic Header” which contains information regarding the general details about the contents of the packet itself. An example of such a basic header is shown in FIG. 5. The fields of the header may be described as follows:

Packet Header: The packet header is 4 byte marker that allows the system to detect for the start of a valid packet.

Protocol: The protocol byte is a versioning flag (1-255) which allows the system to extend functionality while maintaining backwards compatibility.

Head Size: This single byte field contains the physical length of the header (including the Packet Header).

Payload Size: This 2 byte field (short integer) contains the full length in bytes of the payload, basically the packet size minus the header.

Packet Type: This 2 byte field (short integer) specifies the packet type, for example “Login Packet”, “Logout Packet”, etc. Examples of packet types may include any or all of the following:

PT_RESPONSE,
PT_LOGIN,
PT_LOGOUT,
PT_BUDDY_REQUEST_ADD,
PT_BUDDY_REQUEST_GRANT,
PT_BUDDY_REQUEST_DENY,
PT_BUDDY_DELETE,
PT_BUDDY_INFO,
PT_BUDDY_STATUS,
PT_BUDDY_STATUS_CHANGE,
PT_BUDDY_LIST,
PT_SEND_TEXT_MESSAGE,
PT_SEND_PAYLOAD,
PT_CLIENT_INFO_REQUEST,
PT_CLIENT_INFO,
PT_CHAT_SESSION_CREATE,
PT_CHAT_SESSION_ADD,
PT_CHAT_SESSION_REMOVE,
PT_CONNECTION_UPDATE,
PT_DIRECT_FD_UPDATE,
PT_DIRECT_CONNECT,
PT_DIRECT_CONNECT_ACK,
PT_VISIBILITY_STATUS_UPDATE,
PT_VISIBILITY_BLOCK_UPDATE,
PT_BUDDY_CLIENT_INFO,
PT_HEARTBEAT,
PT_NAVIGATE,
PT_NAVIGATE_SEEDLIST,
PT_NAVIGATE_SITE,
PT_NAVIGATE_AWAY,
PT_URL_REQUEST,
PT_URL_REQUEST_INFO,
PT_SEEDLIST_REQUEST,
PT_BLOCKLIST_REQUEST,
PT_BLOCKLIST,
PT_VOICE_START,
PT_VOICE_DATA,
PT_VOICE_STOP,
PT_DISCONNECT,
PT_STATUS_UPDATE,
PT_UDP_DETECT_PRIMARY,
PT_UDP_DETECT_REQUEST,
PT_UDP_PREDICT_BROADCAST,
PT_DISCONNECT_NOTIFY,
PT_DISCONNECT_NOTIFY_MANAGER,
PT_UDP_DETECT_SECONDARY,
PT_UDP_CHANGE_LOCAL_PORT,
PT_RELAY_POINT,
PT_RELAY_POINT_ACK,
PT_RELAY_LIST,
PT_ALERT_SOCKET_CLOSED = 1024,
PT_SYSTEM_MANAGER_REGISTER = 2048,
PT_SYSTEM_PROBER_REGISTER,
PT_SYSTEM_PROBER_PROBE,
PT_SYSTEM_RELAY_REGISTER,
PT_BUDDY_REQUEST_JOIN = 5000,
PT_BUDDY_REQUEST_JOIN_GRANT,
PT BUDDY REMOVE

Packet Sequence: This 2 byte field (short integer) allows the system to maintain packet ordering.

Destination Manager ID: This two byte field (short integer) specifies the destination connection manager, if applicable.

Destination Socket FD (on the Destination Manager): This two byte field (short integer) specifies the socket file descriptor on the destination manager.

Destination Client ID: This 4 byte field (integer) specifies the destination client ID. This is mostly used as a reference and validation—so that we do not send packets down a “tracer” path that might have been reassigned moments earlier.

Source Manager ID: This two byte field (short integer) specifies the source connection manager, if applicable.

Source Socket FD (on the Source Manager): This two byte field (short integer) specifies the socket file descriptor on the source manager.

Source Client ID: This 4 byte field (integer) specifies the source client ID.

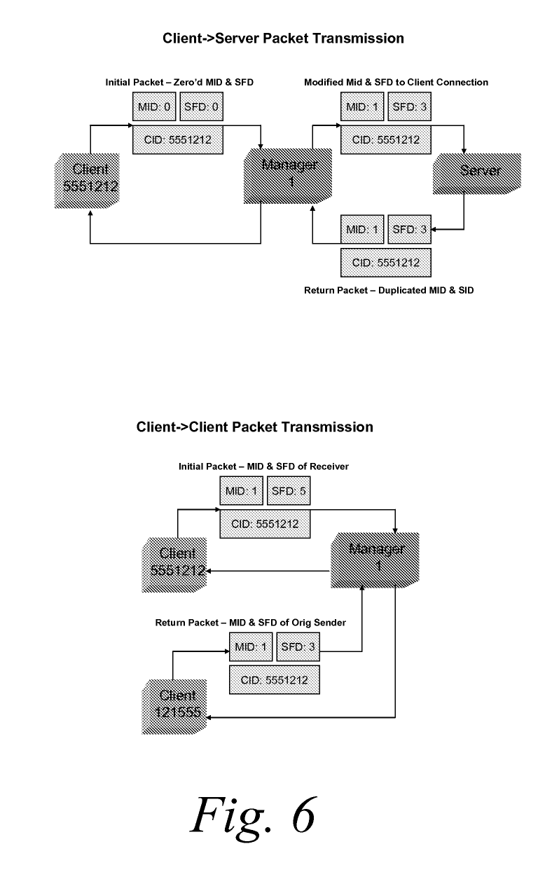

The packets may then be routed through the system based on 3 components: the manager ID, the socket FD and the client ID. The manager ID is set to determine the main packet route. A value 0 means that there is a local and direct connection to the destination, while any number greater than that would cause the system to select the connection manager and pass the packet up. If a packet's manager ID does not match the ID of the receiving connection manager, the packet will be passed on to the appropriate connection manager directly. In other embodiments, routing logic and capability can be implemented to allow for more than 1 step manager passing rather than direct passing. The socket FD is the local network socket ID, either a local port or one for the manager. The client ID is used for 2 purposes: 1) validating the packet is going to the right connection (managers examine this), and 2) if the client ID is 0—then the packet is going to the server. If the manager receives a packet with a client ID of 0, it will add on the manager ID and socket FD to the packet before passing it up to the server so that subsequent response packets can be returned down the same pipe with optimal efficiency. Referring to FIG. 6, examples of packet exchanges using connection managers between clients and between clients and servers is shown.

For example, using the above headers and packet types, a client may submit a login (Packet::PT_LOGIN) request to the server with the following packet fields:
Email Address (std::string)
Password (std::sting)
In this case the manager ID, socket fd and destination client ID may be 0 because this is a server-directed packet.

The server returns a “Packet::PT_RESPONSE” packet with the following packet fields:

(Success)
Packet Type (int) Packet::PT_LOGIN
Result (int) RESPONSE_TYPE_SUCCESS
Client ID (int) the client's registered identification number.
Session ID (int) not currently used.
(Failure)
Packet Type (int) Packet::PT_LOGIN
Result (int) RESPONSE_TYPE_FAILURE
Reason (std::string) Details on why the login failed.

As another example, a client submits a logout request (Packet::PT_LOGOUT) to the server with the following packet fields:

Client ID (int)
Session ID (int) Not currently used.
In this case the manager ID, socket fd and destination client ID
may be 0 because this
is a server-directed packet.

The server returns a “Packet::PT_RESPONSE” packet with the following packet fields:

Packet Type (int) Packet::PT_LOGOUT
Result (int) RESPONSE_TYPE_SUCCESS

As a third example, a client may submit a request to add a buddy (which may be another client that the client would like to always be notified if the two clients are viewing the same page, or which may be another client the client would like to be periodically updated on what sites the buddy is browsing) to the server with the following packet fields:

Client ID (int) Requester's client ID
Buddy's E-Mail Address (std::string)
Buddy's ID (int) Empty since it's not known yet.
Buddy's First Name (std::string) Empty, not filled in by client..
Buddy's Last Name (std::string) Empty, not filled in by client.
Clients's Email Address (std::string) Empty, not filled in by client.
In this case the manager ID, socket fd and destination client ID
may be 0 because this
is a server-directed packet.

Once the server forwards and receives a granted response from the Buddy, the server returns a “Packet::PT_BUDDY_REQUEST_GRANT” packet with the following packet fields:

Packet Type (int) Packet::PT_BUDDY_REQUEST_GRANT
Client ID (int) Requestor's client ID
Buddy's Email Address (std::string)
Buddy's ID (int)
Buddy's First Name (std::string)
Buddy's Last Name (std::string)

### Example of Peer-to-Peer Connection Process

In some cases, direct connections between peers may be difficult to establish due to firewalls or NAT devices. In these cases, any of the following techniques may be used. If a direct connection is established at any moment in these processes, the subsequent steps of these processes may be terminated as direct peer-to-peer communication begins.

Step 1 (Login Identification): This step identifies a user's UDP connection type: open or behind a firewall or NAT. Additionally, in the cases of users behind NATs, this step identifies users with difficult NATs/Firewalls that use port relocating. On login, User 1 establishes independent connections with two (not one) connection managers, Connection Manager 1 and Connection Manager 2. The two connection managers send back to User 1 the source IP and port information they received from User 1. Some NATs/Firewalls change the user's port numbers. When this happens, the port number that the user provides may be incorrect because it has been changed by the NAT/Firewall. Two varieties of port number changes are:
1. Port 1024. Some NATs change the user's initial port number to 1024 and assigns subsequent port numbers incrementally from there (1025, 1026 . . . and so on).
2. Last Port Used+. Some NATs change the user's initial port number to the last used port number plus one. So if the last known UDP port was 3500, the next assigned port number would be 3501. Future port numbers are assigned incrementally from this number (3502, 3503 . . . and so on).

User 1 can determine if his NAT is changing his ports by cross-referencing the information he receives back from each Connection Manager. By cross-referencing the port numbers, User 1 will identify a) if his NAT is relocating his ports and b) if so, what is the protocol of the relocation: 1024+ or last port used. In some embodiments, the protocol for port relocation is saved on the user's computer.

Step 2 (Saving Connection Information and login credentials): Once User 1 has determined his connection type, he sends this information to a Server (via the Connection Manager). The Server then saves this connection information along with his login credentials to the Database. This connection information may include: NAT presence, source port, destination port and port relocating information (1024+ or last port used), if any.

Step 3 (Initial navigation): User 1 navigates to a URL, in this example: http://www.yahoo.com/, and sends this information to the Server via the Connection Manager. User 2 is already present at this URL. The Server records User 1's current URL and saves it to the Database.

Step 4 (Seed List retrieval): The Server sends to User 1, via the Connection Manager, a list of other users at http://www.yahoo.com; this list can also be called the “Seed List”. The Seed List is generated by the Server by querying the Database. The Seed List also contains Connection Information for each user at that site. This list will include User 2, who is also at http://www.yahoo.com. The Seed List includes not only the Usernames, but also primary and secondary IP addresses and ports for each user. The Primary port is the port number that a User employs on a network. When a User is behind a NAT or firewall, this number is assigned by the router or network device. The secondary port is the port number that is broadcast as the user's “global” IP address, likely the router or network device IP number.

Step 5 (Initial attempt failure): User 1 attempts to connect with the other users in the Seed List. User 1 attempts to contact User 2 establishing a UDP connection through User 1's NAT/firewall. If User 1 fails to establish a direct communication with User 2 after a certain amount of time (resulting in a Time-Out Failure), User 1 routes a message to User 2 (via the Connection Manager) that he cannot connect with User 2. In this message, User 1 also provides User 2 with User 1's Connection Information, which includes the source port number used to penetrate User 1's NAT/firewall.

Step 6 (Reverse connection attempt): User 2 attempts to connect with User 1 via User 1's source port.

Step 7 (Execute Port Probing): If User 2 fails to establish a direct connection via User 1's source port, User 2 determines if User 1 is behind a port relocating NAT from User 1's Connection Information. If so, User 2 attempts to connect to User 1 on either port 1024 or the last saved port, as determined by User 1's Connection Information.
Step 7A: User 2 attempts to connect to User 1 on next port per User 1's Connection Information (either port 1024 or last saved port number).
Step 7B: If User 2 gets a timeout failure in Step 7A, User 2 attempts to connect to User 1 on a specified number of ports above the last port number attempted (currently this is set to 1,000 ports).
Step 7C: If User 2 gets a timeout failure after this attempt, User 2 sends a message to User 1 (via the Connection Manager) that he has failed to connect to User 1 in Steps 7A and 7B.

Step 8 (Continue Port Probing): User 1 determines if User 2 is behind a port relocating NAT from User 2's Connection Information. If so, User 1 attempts to connect to User 2 on either port 1024 or the last saved port, as determined by User 2's Connection Information.
Step 8A: User 1 attempts to connect to User 2 on next port per User 2's Connection Information (either port 1024 or last saved port number).
Step 8B: If User 1 gets a timeout failure in Step 8A, User 1 attempts to connect to User 2 on a specified number of ports above the last port number attempted (currently this is set to 1,000 ports).
Step 8C: If User 1 fails to establish a connection to User 2, no further connection attempts are made.
   In some embodiments, if a user fails to connect to a second user, alternative methods of establishing a connection between the two users are attempted. In one of these embodiments, for example, the users may attempt to connect through a third client, which may be providing relay services as described above.

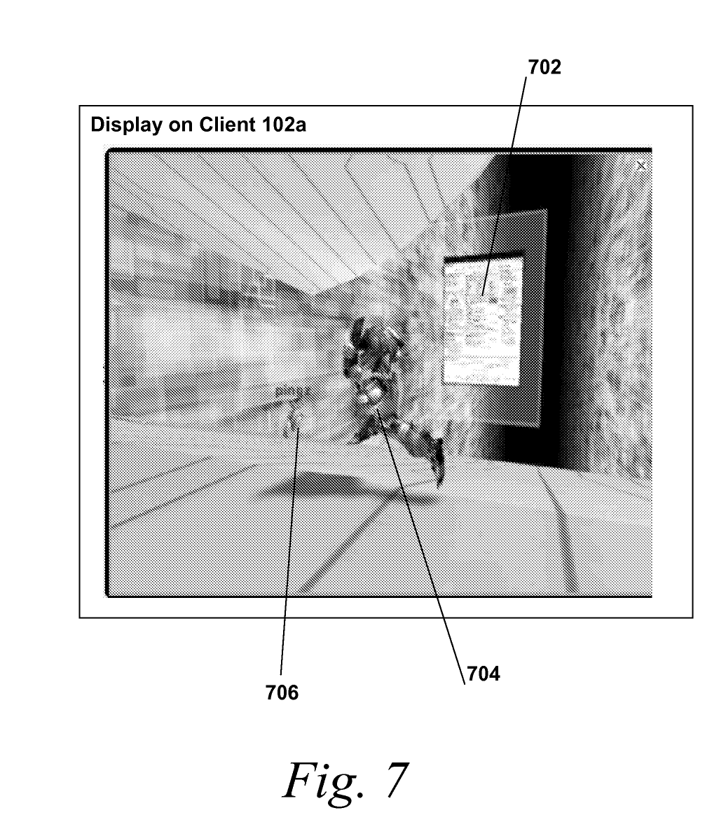

Referring now to FIG. 7, a screen shot depicts one embodiment of a system in which the first computer displays a three-dimensional environment displaying an avatar associated with a user of a second computer connected to the first computer. In one embodiment, the first computer 102a displays to a user a first web browser 702. The first computer 102a receives from a server, such as the community URL serve 100 (not shown), address information associated with a second computer and establishes a connection between the first computer and the second computer. In one embodiment, and as shown in FIG. 7, the first computer displays, in a three-dimensional environment at least one avatar 704 representative of the user. In FIG. 7, the first computer also displays at least one avatar 706 representative of a user of the second machine. In some embodiments the avatar 704 and the avatar 706 are displayed on each of the first computer and the second computer and the users of each of the first computer and the second computer interact via their respective avatars. In one of these embodiments, the first computer and the second computer exchange audio, video, or text-based communications.

In one aspect, methods and systems for enabling peer-to-peer communication among visitors to a common website allows visitors to a website to connect and communicate with one another regardless of the operator or design of the website. Broadly speaking, the methods and systems described herein provide a web browser sending URLs of currently viewed pages to a central server collecting the currently viewed URLs of a number of users. Upon receiving a user's currently viewed URL, the server responds with other users also viewing the same or similar pages. The user's computer can then directly connect to the other computers viewing the page, allowing the users to communicate with each other. In this way, a number of people visiting the same site can communicate with each other to share thoughts, opinions, and interests relating to the page and to socialize with one another via 3D avatar representations of themselves. Further, this communication can happen without any involvement by the administrator of the website, and without any changes to the website.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of methods and systems for enabling peer-to-peer communication among visitors to a common website, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for enabling peer-to-peer communication among visitors to a common website, the method comprising:
determining, by a server unaffiliated with a first uniform resource locator, that a first computer is accessing the first uniform resource locator via a first web browser;
determining, by the server, that a second computer is accessing a second uniform resource locator via a second web browser, the second uniform resource locator sharing at least a hostname with the first uniform resource locator;
sending, from the server to the second computer, address information identifying the first computer; and
establishing a connection between the second computer and the first computer.

2. The method of claim 1 further comprising displaying, to a user of the first computer, a three-dimensional environment incorporating the first web browser.

3. The method of claim 1 further comprising displaying, in the three dimensional environment, at least one avatar representative of a user.

4. The method of claim 1 further comprising sending at least one of: voice, avatar, or text data over the established connection.

5. The method of claim 1 further comprising:
identifying a plurality of computers accessing the first uniform resource locator;
applying a filter to address information identifying each of the plurality of computers; and
sending, from the server to the second computer, address information identifying each of a subset of the plurality of computers, responsive to the application of the filter.

6. The method of claim 1 further comprising determining that the second uniform resource locator is identical to the first uniform resource locator.

7. The method of claim 1 further comprising determining that the second uniform resource locator is identical to the first uniform resource locator except for one or more query strings.

8. A method for enabling peer-to-peer communication among visitors to a common website, the method comprising:
displaying, by a computer, a first web browser to a user;
identifying, by the computer, a uniform resource locator currently accessed by the user via the first web browser;
receiving, by the computer, address information identifying at least one second computing device as accessing a second uniform resource locator via a second web browser, the second uniform resource locator sharing at least a hostname with the first uniform resource locator; and
establishing a connection between the computer and the second computer.

9. The method of claim 8, wherein displaying further comprises displaying, by a computer, a three-dimensional environment comprising a first web browser to a user.

10. The method of claim 8, wherein displaying further comprises displaying, in the three dimensional environment, at least one avatar representative of a user.

11. The method of claim 8 further comprising sending at least one of: voice, avatar, or text data over the established connection.

12. The method of claim 8 further comprising determining that the second uniform resource locator is identical to the first uniform resource locator.

13. The method of claim 8 further comprising determining that the second uniform resource locator is identical to the first uniform resource locator except for one or more query strings.

14. A system for enabling peer-to-peer communication among visitors to a common website, comprising:
a first computer comprising a first web browser;
a server i) determining that the first computer is accessing a first uniform resource locator via the first web browser, wherein the server is unaffiliated with the first uniform resource locator; ii) determining that a second computer is accessing a second uniform resource locator via a second web browser, the second uniform resource locator sharing at least a hostname with the first uniform resource locator; and iii) sending, to the second computer, address information identifying the first computer; and
the second computer establishing a connection to the first computer.

15. The system of claim 14, wherein the first computer further comprises means for displaying, to a user of the first computer, a three-dimensional environment incorporating the first web browser.

16. The system of claim 15, wherein the first computer further comprises means for displaying, in the three dimensional environment, at least one avatar representative of a user.

17. The system of claim 14, wherein the second uniform resource locator is identical to the first uniform resource locator.

18. The system of claim 14, wherein the second uniform resource locator is identical to the first uniform resource locator except for one or more query strings.

19. The system of claim 14, wherein one of the first or second computers sends one of: voice, avatar, or text data over the established connection.

20. A system for enabling peer-to-peer communication among visitors to a common website, comprising:
a display on a computing device comprising a first web browser;
a processor in communication with the display and identifying a uniform resource locator currently accessed by a user of the computing device via the first web browser; and
a transceiver, in communication with the processor, receiving address information that identifies at least one computing device as accessing a second uniform resource locator via a second web browser, the second uniform resource locator sharing at least a hostname with the first uniform resource locator; and
establishing a connection with the at least one second computing device.

21. The system of claim 20 wherein the display comprises a three-dimensional environment comprising a first web browser to a user.

22. The method of claim 21, wherein the display comprises, in the three dimensional environment, at least one avatar representative of a user.

23. The system of claim 20, wherein the transceiver sends at least one of: voice, avatar, or text data over the established connection.

24. The system of claim 20, wherein the second uniform resource locator is identical to the first uniform resource locator.

25. The system of claim 20, wherein the second uniform resource locator is identical to the first uniform resource locator except for one or more query strings.
